(19) United States
(12) Patent Application Publication
(10) Pub. No.: US 2005/0066355 A1
(43) Pub. Date: Mar. 24, 2005

(54) System and method for satellite broadcasting and receiving encrypted television data signals

(75) Inventors: Daryl Carvis Cromer, Apex, NC (US); Joshua James Jankowsky, Raleigh, NC (US); Howard Jeffrey Locker, Cary, NC (US); Andy Lloyd Trotter, Raleigh, NC (US); James Peter Ward, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/666,160

(22) Filed: Sep. 19, 2003

(51) Int. Cl. H04N 7/167; H04L 9/00; H04K 1/00; H04N 7/16

(52) U.S. Cl. 725/31; 725/25; 380/282; 380/285; 380/287

(57) ABSTRACT

A system for broadcasting television signals transmits both encrypted program content and access control data over a satellite system to be received by a number of individual receivers, each of which has registered with the program provider by providing a public cryptographic key and hash codes representing the serial numbers of critical components within the receiver. The access control data, which is addressed to an individual receiver, includes data encrypted with the public key of the receiver, indicating the program content to be decrypted by the receiver using its private key. Whenever the receiver is powered on, the hash codes are generated and stored to ensure the components have not been changed. Each transmission from the receiver to the program provider is validated by checking the hash codes.

### BACKGROUND OF THE INVENTION

1. Field of the Invention

This invention relates to Direct Broadcast Satellite (DBS) television transmission systems, and, more particularly, to a system and method providing for the satellite transmission of encrypted data to be received and displayed by receivers while preventing the unauthorized reception of such data by other receivers.

2. Background Information

FIG. 1 is a block diagram of a Direct Broadcast Satellite System (DBS), in which a program provider 10 sends a television signal to an “uplink site,” 12 having a large dish antenna 14, which transmits a signal to one or more orbiting DBS satellites 16. These satellites 16 relay the signal to be received through small dish antennas 18 by a number of DBS receivers 20 connected to conventional television sets 22. In the uplink site 12, the video and audio portions of the signal from the program provider 10 are compressed and formatted into data packets before transmitting the data packets to the satellites 16.

To prevent the unauthorized reception of information transmitted from the satellites 16, the video data is additionally encrypted in the uplink site 12, using a standard method such as the Digital Encryption Standard (DES) algorithm. Inside each of the DBS receivers 20, an access card 24 stores codes determining which portions of the video data are to be decrypted, as determined, for example, by the programming that has previously been purchased by the user of the DBS receiver 20.

The signals transmitted to and from the satellites 16 are composed of digital data packets, including video and audio data packet containing the video and audio portions of the television programming, respectively, and additionally including conditional access (CA) packets having information addressed to individual DBS receivers 20. For example, the CA packets contain information stored in the access card 24 within a DBS receiver 20 for use in decrypting scrambled program data.

Each of the DBS receivers 20 includes a tuner/demodulator 26, which isolates a particular modulated signal received by the receiving dish antenna 18, and which demodulates this signal to produce a digital data stream. This digital data stream is provided as an input to a forward error correction (FEC) block 28, which applies an error correction algorithm to the data to correct errors introduced during satellite transmission. The resulting corrected digital data stream is then provided as an input to the transport integrated circuit (IC) 30.

The transport IC 30 has a bidirectional interface to the access card 24, through which the access card 24 receives encrypted keys that are transmitted to the receiving dish antenna 18 within the CA data packets. Within the access card 24, these encrypted keys are decrypted, with the decrypted keys being returned through this interface for storage in a register within the transport IC 30. Within the transport IC 30, these decrypted keys are used to decrypt encrypted (scrambled) program content.

The transport IC 30 provides a digital video signal as an input to a video decoder 32 and a digital audio signal as an input to an audio decoder 34. Within the video decoder 32, the digital video signal is decompressed according to a Motion Picture Experts Group (MPEG) standard, using an MPEG2 video decompression algorithm. Within the audio decoder 34, the digital audio signal is decompressed using an MPEG audio decompression algorithm. The transport IC 30, the video decoder 32 and the audio decoder 34 have access to random access memories 36, 37, and 38, respectively, for storing intermediate results and for buffering. The decompressed digital video signal is provided as an input to an NTSC encoder/DAC 39, which generates an analog video signal encoded according to the NTSC standard. The decompressed digital audio signal is provided as an input to an audio DAC 40, which generates an analog audio signal. These analog signals are provided as inputs to a radio frequency (RF) modulator 42, which combines these signals into a modulated signal generated at a frequency that can be received by a standard television receivers, such as the television set 22 connected to the DBS receiver 20.

Operations within the DBS receiver 20 are also controlled through a microprocessor 44, which receives user inputs from a remote control 46 through an infrared (IR) receiver 48 operating in response to the remote control 46. The microprocessor 44 executes program instructions stored in a read-only memory (ROM) 50.

The DBS receiver 20 additionally includes a modem 52 connected to the microprocessor 44 through a system bus 53 and to the program provided 10 through the public switched telephone network 54. The modem 52 places calls to the program provider 10 to transmit information regarding pay-per-view programs purchased by the user.

The access card 24 is removable and replaceable within the DBS receiver 20. The DBS receiver 20 does not operated within an installed access card 24 installed. Occasionally, the encryption procedures used within the DSS system may be changed, with new versions of the access cards 24 being supplied to all subscribers to the system. The first time an access card 24 is activated within a DBS receiver 20, data describing the serial number of the DBS receiver 20 is recorded with the access card 24, so that the access card 24 cannot be subsequently removed and used within another DBS receiver 20.

Unfortunately, a number of customers of broadcast services, including DBS services, see nothing wrong with subverting security mechanisms of the service provider by physically tampering with a portion of the system within their receiver, such as the access card 24, or by subjecting the receiver to various cryptographic attacks to expose keys or to deceive the receiver concerning the source of messages it receives. Therefore, a problem with the conventional process described above arises from the fact that a number of individuals have learned how to produce counterfeit access cards 24, either by building cards or by modifying existing cards. Such cards can then be used to view channels and programming for which fees have not been paid. What is needed is a method preventing the successful use of counterfeit or unauthorized circuits to decode scrambled video data.

One method to prevent the use of such unauthorized circuits is to change the method in which a broadcast signal is scrambled often enough that it is difficult or impossible for a fixed, invariable decoder to be developed by any unauthorized person to successfully descramble a scrambled broadcast signal over an extended period of time. This method is achieved, for example, as described in U.S. Pat. No. 4,908,834, within a system including television receivers each having a decoder with periodically changed memory modules. The decoder only functions to properly descramble a scrambled broadcast signal when a changeable system-wide code is available in the decoder. The code can either be carried to the memory module, or an internal code unique to the decoder and resident in the decoder can be combined with an external code in the memory module, and also unique to the decoder, to generate the common system-wide system code. Program viewership is written on the removable memory module, which is returned to a central facility for later subscriber billing. Another method for providing a decoder with a security module that can be replaced following a breach of system security is described in U.S. Pat. No. 5,237,610. What is needed is a secure method providing for payment for programming without requiring the expense and inconvenience of changing a module within each receiver.

Another method for preventing the use of counterfeit or unauthorized circuits to decrypt data is to make reverse engineering of a cryptographic unit within a device impractical or extremely difficult. An application of this method is described in U.S. Pat. No. 6,289,455 in the form of a unit for regulating access to digital content including an interface control processor and a specialized cryptographic unit that protects access to a memory. The cryptographic unit adds rights keys allowing access to the content by transforming data received from the control processor, with the results being stored in the protected memory. The cryptographic unit then produces content decryption keys by using stored rights keys to transform other data received from the control processor. Because the control processor does not have the ability to directly access the protected memory, the security can remain effective even if the control processor is compromised. To prevent reverse engineering of the cryptographic transformations, an algorithm generator uses random sources to produce algorithm definitions in machine-readable form. Because the generator itself does not contain any secrets, it can be submitted for open revue.

Another method to prevent the surreptitious use of counterfeit or unauthorized circuits to receive programming is to change a number used in generating cryptographic keys every few seconds, as described in U.S. Pat. No. 6,252,964, which describes the application of a cryptographic system to a broadcast system, which may be wired, such as cable TV, or wireless, including a DBS system. The cryptographic system uses symmetrical key cryptographic techniques, such as the DES algorithm, to encrypt and decrypt program information and public key cryptographic techniques, such as the well-known RSA algorithm, to transmit a copy of a key used in symmetrical key cryptographic techniques from the service provider to the receiver. The key used to encrypt program information, called a Control Word, is generated by a random number generator or by a sequential generator with a randomization algorithm, being frequently regenerated and replaced, as often as every few seconds. The Control Word is encrypted using a DES algorithm for inclusion within an entitlement management message (EMM) to be sent to an individual receiver after encryption using the public key of the individual receiver.

Yet another method to prevent the surreptitious use of counterfeit or unauthorized circuits to receive programming is to use a secure processor and associated secure non-volatile storage to perform encryption and decryption of commands and data, with a private key, control algorithm, and the like being stored in the associated secure storage. Such an arrangement is described in U.S. Pat. No. 5,742,677, with secure data being loaded into the secure, non-volatile storage by multiple service providers and by the user of the receiver. A characteristic of such an arrangement is that a surreptitious attempt to break into the secure processor to obtain the data stored in secure storage causes the data to be lost and the processor to be rendered functionally inactive.

U.S. Pat. No. 6,307,937 describes the use of an adapter card in a computer to provide conditional access by the computer to incoming data streams that the computer is authorized to receive, with the security of the information being maintained by keeping a list of addresses corresponding to data streams that the computer is authorized to receive. After receiving a frame and determining its address, the adapter card determines whether the frame address matches an address maintained in an address table. The adapter card then processes and transmits only those frames of data streams that the computer is authorized to receive.

U.S. Pat. No. 6,411,712 describes a digital broadcast receiver having a first unit for receiving broadcast signals transmitted from a transmitter, a second unit capable of removably coupling to the first unit for applying an operation specific to the second unit to the received signal, an encryptor equipped in the first unit for encrypting the received signal and for providing the encrypted signal to the second unit, and a decryptor equipped in the first unit for decrypting the signal encrypted by the encryptor transferred through the second unit.

A decoder for descrambling encoded satellite transmissions comprises an internal security module and a replaceable security module. The program signal is scrambled with a key and then the key itself is twice encrypted and multiplexed with the scrambled program signal. The key is first encrypted with a first secret serial number (SSNt) which is assigned to a given replaceable security module. The key is then encrypted with a second secret serial number (SSNZ) which is assigned to a given decoder. The decoder performs a first key decryption using the second secret serial number (SSNZ) stored within the decoder. The partially decrypted key is then further decrypted by the replaceable security module using the first secret serial number (SSNt) stored within the replaceable security module. The decoder then descrambles the program using the twicedecrypted key. The replaceable security module can be replaced, allowing the security system to be upgraded or changed following a system breach. Either security module may become the active security module to finally decrypt the seed, selectable by a signal transmitted from the encoder.

Also disclosed is a method for transmitting the encrypted keys and secret serial numbers to a plurality of broadcasters who may in turn multiplex this signal with their own program signals so that any given channel received by a subscriber contains the key and secret serial numbers. Additionally, the decoder may be upgradeable to accept both analog and digital video signals without significant redundant circuitry.

U.S. Pat. No. 4,829,569 describes a subscription television system in which individual decoders are enabled to receive individually addressed messages is disclosed. The composite signal, including video and teletext, also comprises addressed packets, which are detected by decoders and which indicate that a message addressed to a particular subscriber is forthcoming, and system control data. The decoder detects an addressed packet addressed to itself, whereby it is enabled to select the appropriate teletext message and to display the same. In a preferred embodiment, both address packets and teletext are encrypted. The addressed packet is decrypted using a decoderspecific code and a system key transmitted as part of the system control data, while the teletext packet is decrypted using the system key, but cannot be received until the addressed packet has been decrypted.

### SUMMARY OF THE INVENTION

In accordance with an aspect of the invention, a receiver is provided for receiving program content and for displaying the program content under predetermined conditions, wherein the receiver includes a component identified by a computer readable serial number, data storage, a signal processor, and a first microprocessor. The data storage stores access data determining programming to be decrypted by the receiver, a public cryptographic key, a private cryptographic key for decrypting information encrypted with the public cryptographic key, and a code representing the component identifier. The signal processor decrypts the encrypted program content in accordance with the access data stored within the data storage. The receiver periodically performs a first method comprising reading the computer readable serial number, generating a hash value representing the computer readable serial number, and storing the hash value in the data storage. The receiver additionally performs a second method comprising reading the hash value from the data storage, and transmitting data indicating programming to be decrypted together with the hash value to a program provider. The receiver further performs a third method comprising receiving a secret code from the program provider, decrypting the secret code with the private cryptographic key stored in the data storage, and storing a decrypted form of the secret code as the access data in the data storage.

In accordance with another aspect of the invention, a computer system is provided for controlling access to encrypted programming transmitted to a plurality of receivers from a program provider, The computer system includes input means for receiving data signals from each receiver in the plurality of receivers, output means for transmitting a secret code indicating a portion of the encrypted programming to be displayed by each receiver in the plurality of receivers, data storage, a processor; and a database. The database stores a data record for each receiver in the plurality of receivers, wherein each the data record includes a first data field identifying an address for sending data to the receiver, a second data field for storing a hash value for the receiver, and a third data field for storing a public cryptographic key of the receiver.

The processor of the computer system is programmed to perform a first method including:
receiving a message from a receiver in the plurality of receivers including data identifying the receiver, data indicating programming to be decrypted by the receiver, and a hash value;
identifying a data record within the database from the data identifying the receiver,
determining the hash value received in the message matches the hash value stored in the data record,
generating a secret code identifying programming to be decrypted by the receiver,
encrypting the secret code with a public cryptographic key of the receiver stored in the data record to form an encrypted version of the secret code; and
transmitting the encrypted version of the secret code to the receiver.

### BRIEF DESCRIPTION OF THE DRAWINGS

FIG. 1 is a block diagram of a conventional satellite television system;

FIG. 2 is a block diagram of a satellite television system built in accordance with the invention;

FIG. 3 is a flow chart of a process occurring within the manufacture of a receiver within the satellite television system of FIG. 2;

FIG. 4 is a flow chart of a process occurring as the receiver within the satellite television system of FIG. 2 is initialized following power-on;

FIG. 5 is a flow chart of a process occurring within the system of FIG. 2 during a process of registering a receiver to receive and decrypt programming from a program provider therein;

FIG. 6 is a flow chart of a process occurring within a computer system of the program provider in the system of FIG. 2 during a process of verifying components within the receiver therein; and

FIG. 7 is a flow chart of a process occurring within the receiver in the system of FIG. 2 during the process of updating keys to be used for decrypting program content.

### DETAILED DESCRIPTION OF THE INVENTION

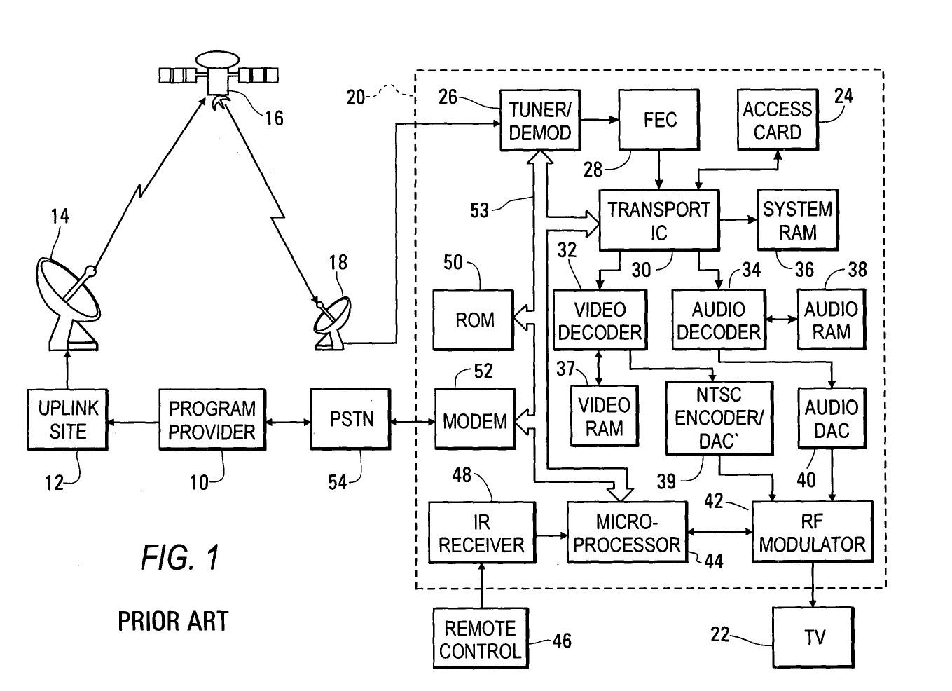

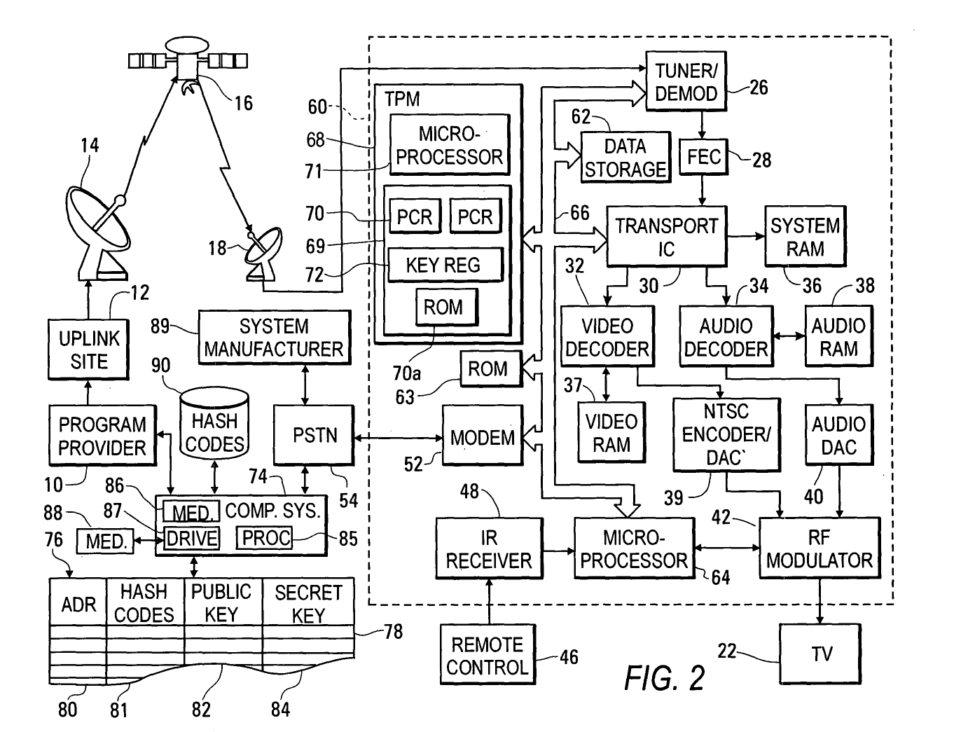

FIG. 2 is a block diagram of a satellite television system operating in accordance with the invention, including an improved DBS receiver 60 built to operate in accordance with the invention. Many of the components within the improved receiver DBS 60 are similar or identical to corresponding components within the conventional DBS receiver 20, described in detail above in reference to FIG. 1, and are therefore accorded like reference numbers.

In the improved DBS receiver 60, the access cards 24, used in the conventional DBS receiver 20 to store codes determining which portions of the video data are to be decrypted, are eliminated, being replaced by data storage 62 in which such codes are stored. For example, the transport IC 30 operates as a signal processor decrypting program data in response to codes stored within data storage 62, which 62 forms a computer readable medium in which both data and program instructions may be recorded. A portion or all of data storage 62 may be non-volatile. A system microprocessor 64 accesses data and program instructions stored within the data storage 62 and provides signals through a system bus 66 controlling the transport IC 30 so that programs received by the DBS receiver 60 are appropriately decrypted. Preferably, the receiver 60 additionally includes another computer readable medium in the form of a read-only memory 65 storing at least instructions to be executed by the system microprocessor 64 during initialization, with these instructions thus being protected from being overwritten. The microprocessor 64 retains the function of driving the RF modulator 42 to tune the output of the DBS receiver 60 to a channel selected by the remote control 46 through the IR receiver 48. Instructions for programs to be executed within the system microprocessor 64 may also be provided in the form of a computer data signal embodied in a carrier wave transmitted to the modem 52 or transmitted through the satellite 16.

The improved DBS receiver 60 additionally includes a trusted platform module TPM 68, including data storage 69, having a number of program control registers PCRs 70, storing data used to determine that no one has replaced various components within the receiver 60, and a read-only memory (ROM) 70a, such as an EEPROM. The TPM 68 additionally includes a separate microprocessor 71. The PCRs 70 are configured so that data can be written to them only by the microprocessor 71 within the TPM 68, but so that data can be read from them by the system microprocessor 64, as well as by the TPM microprocessor 71. Various components within the receiver 60, such as the TPM 68, the data storage 62, and the microprocessor 64, which are considered to be critical components, have unique serial numbers that can be read by a program executing within the TPM microprocessor 71. The TPM 68 is initialized during the process of manufacturing with a unique public and private key pair that is stored in a key register 72. Additionally, the manufacturing process of the improved DBS receiver 60 processes a certificate against the public key stored in the key register 72 for subsequent use to verify the authenticity of a message from the receiver 60, with the certificate being stored within the data storage 69 of the TPM 68.

The program provider system 10 is connected to a computer system 74 with access to a customer database 76 having a data record 78 for each DBS receiver 60 to which satellite broadcast data is to be sent. These data records 78 each include data within a first data field 80 storing an address by which CA data packets transmitted by the satellite 16 are sent only to the particular DBS receiver 60, a second data field 81 storing hash codes that are used to verify the authenticity of the receiver 60 transmitting data to the computer system 74, a third data field 82 storing the public key the DBS receiver 60 associated with the data record 78, and a fourth data field 84 storing a program key associated with the data record 78. The computer system 74 is also connected to the public switched telephone network 54 to receive data from the receivers 60 for storage within the database 76.

The computer system 74 is of a conventional type including a processor 85, a computer readable medium 86, such as a hard disk drive, on which computer usable instructions are stored for use in the execution of programs, and additionally having a drive 87 for reading data and instructions stored on a removable computer readable medium 88, such as a floppy magnetic disk or an optical disk. Instructions for programs to execute within the computer system 74 may also be provided in the form of a computer data signal embodied in a carrier wave, transmitted, for example, over the public switched telephone network 54.

Inputs to the computer system from a number of receivers 60 are provided through the telephone network 54 and through a conventional interface to the telephone network. In accordance with a preferred version of the invention, codes generated by the computer system 74 are transmitted to individual receivers 60 through an interface to the program provider 10, to be inserted in CA data packets addressed to the receivers and transmitted along with program content by means of the satellite 16. Alternately, codes generated within the computer system 74 may be transmitted to receivers 60 through the telephone network 54.

Each of these receivers 60 has a unique public key that has a conventional cryptographic relationship with its private key, which is stored in the key register 72 of its TPM 68. This relationship provides that a message encrypted with the public key of the receiver 60 can be decrypted using the private key of the receiver 60. The public key may be stored in the key register 72, or in data storage 62.

Preferably, the computer system 74 of the program provider additionally receives data from the system manufacturer 89 on a periodic basis, with this data being used to determine the integrity of components within receivers 60 trying to communicate with the computer system 74. Such periodic communications may occur over the public switched telephone network 54. For example, the system manufacturer 89 may provide possible values for expected hash codes to be generated using the serial numbers of critical components within receivers 60, with such values being stored in a data structure 90 accessible by the computer system 74 for comparison with hash codes supplied by receivers 60 attempting to register with the computer system 74.

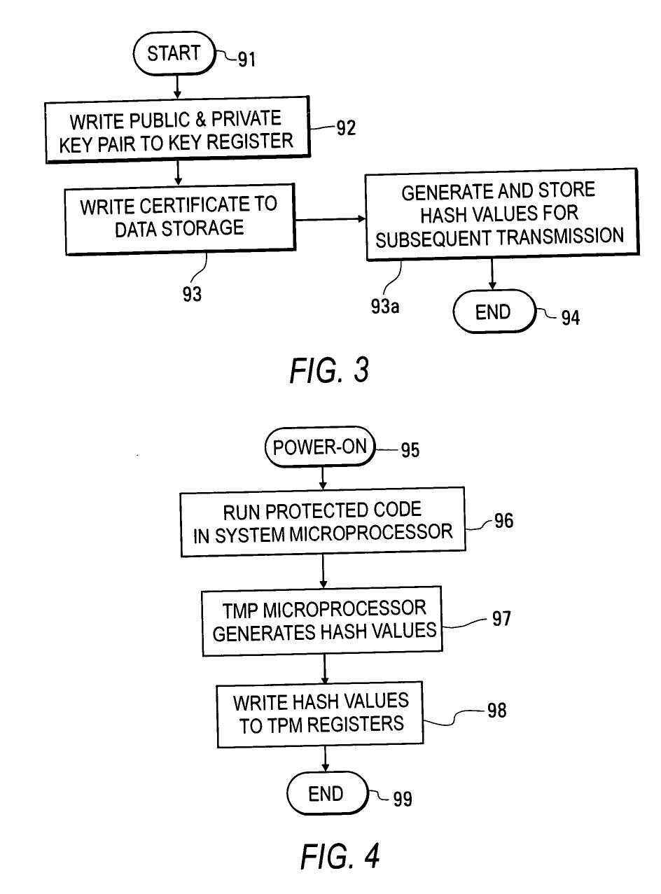

FIG. 3 is a flow chart of a process occurring within the manufacture of the improved DBS receiver 60. This process is started in step 91 after the manufacturer installs the TPM 68 within the receiver 60. In step 92, the manufacturer writes a private and public key pair to the key register 72 within data storage 20 of the TPM 68. Then, in step 93, the manufacturer writes a digital certificate to data storage 72 within the TPM 68, with the digital certificate including the public key assigned to the receiver 60. In accordance with the present invention, in step 93a, the manufacturer generates and stores hash values based on the serial numbers of critical components within the receiver 60 and on the certificate stored in step 93. These hash values are stored within the computer system of the system manufacturer 89. Then, this process ends in step 94. Portions of the data storage 69 within the TPM 68 may be implemented as an EPROM that can only be written to during a manufacturing process.

Preferably, the hash values stored by the system manufacturer 89 in step 93a during the manufacture of a number of receivers 60 are periodically transmitted to the computer system 74 of the program provider 10 for storage within the data structure 90. This process provides the program provider 10 with a knowledge of the hash codes to expect from a new receiver 60 attempting to register with the program provider's computer system 74. While a single system manufacturer 89 and a single program provider 10 are shown in FIG. 2, it is understood that a number of system manufacturers 89 and a number of program providers 10 may be interconnected to exchange information in this way. It is further understood that other means, such as the Internet and the Postal Service, may be used to send batches of such data.

FIG. 4 is a flow chart of a power-on reset process occurring each time the improved DBS receiver is powered-on in step 95. Next, in step 96, the system microprocessor 64 runs an initialization routine from protected code stored in ROM 63, which cannot be overwritten. Then, in step 97, the microprocessor 71 within the TPM 68, executing code stored within ROM 70a of the TPM 68, generates hash values from the serial numbers of critical components. Next, in step 94, these hash values are written to the PCR registers 70 within the TPM 68 by the microprocessor 71.

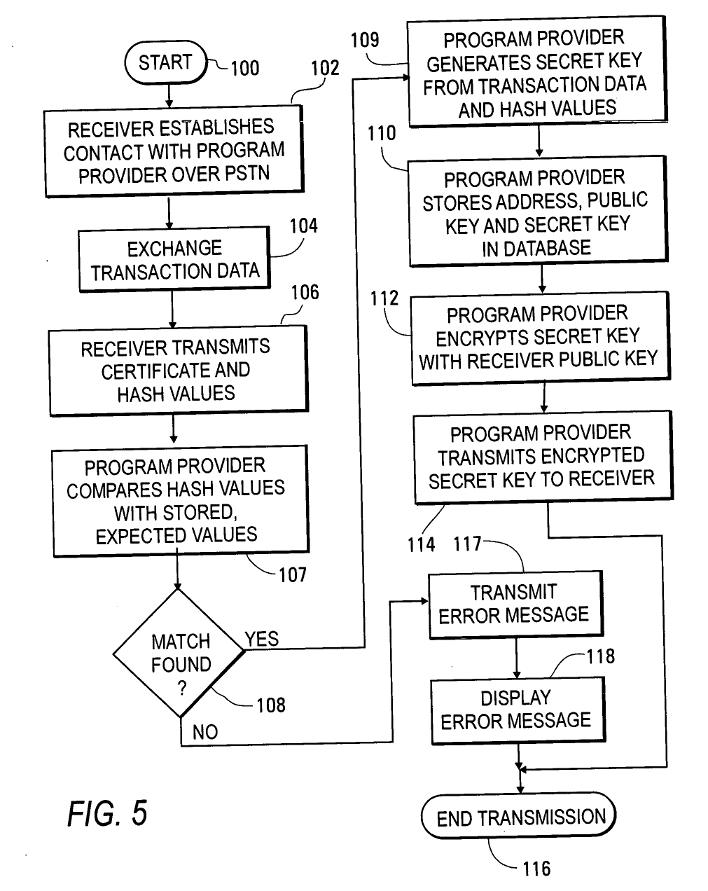

FIG. 5 is a flow chart of steps occurring during a process of registering the improved DBS receiver 60 with the program provider 10 to receive data transmitted by the program provider 10. This process is started in step 100 in response to a user input through the remote control 60 indicating a desire to begin the registration process. Such user inputs are provided, for example, by the owner or operator of the receiver 60 or by a technician installing the receiver 60 and associated hardware, such as the receiving antenna 18.

After the registration process is started in step 100, the DBS receiver 60 establishes a connection with the program provider 10 over the public switched telephone network 54, using the modem 52. It is understood that another bidirectional communication channel can alternately be used in place of the telephone network 54. Then, in step 104, transaction data is exchanged between the receiver 60 and the program provider 10. For example, this exchange of transaction data may include payment for program services using a credit card, in a manner well known to those skilled in the art of electronic commerce, with security being established through the use of a Secure Sockets Layer.

Next, in step 106, the receiver transmits its digital certificate, which has been stored within the TPM during the process of manufacturing the receiver 60, as explained above in reference to FIG. 3, along with the hash values, which have been stored in PCRs 70 during the most recent power-on reset process, as explained above in reference to FIG. 4, to the program provider 10. Preferably, the hash values are encrypted or “signed” using the private key of the receiver 60 before transmission. Since the digital certificate of the receiver 60 includes its public key, the program provider 10, upon receiving this transmission, uses this public key to decrypt the hash values.

Then, in step 107, the program provider 10 compares the hash values transmitted by the receiver 60 in step 106 with the expected hash values previously received from the system manufacturer 89 and stored within the data structure 90. If a match is found, as determined in step 108, it is known that the receiver 60 has a valid configuration, in which none of the critical components has been changed following the manufacturing process, so the program provider continues the registration process, proceeding to step 109 to generate a secret key for transmission to the receiver 60. This secret key, generated in response to the transmission data exchanged in step 104, provides an indication of the programming that can be decrypted following program purchases.

Next, in step 110, the program provider 10 writes the address of the receiver 60 to the data record 78 of the customer database 76, corresponding to the receiver 60 in the first data field 80, additionally writes the hash codes supplied by the receiver to the second data field 81, additionally writes the public key of the receiver 60 to the third data field 82, and additionally writes the encrypted secret key generated in step 110 to the fourth data field 84. Next, in step 112, the program provider 10 encrypts the secret key with the public key of the receiver 60, which has been received as part of the digital certificated transmitted in step 106. The address stored in data field 80 is used as a receiver identifier to locate the data record corresponding to a particular receiver 60. Next, in step 114, the program provider transmits the encrypted secret key to the receiver 60. Finally, in step 116, the connection of over the telephone network 54 is ended.

If it is determined in step 108 that the hash values transmitted by the receiver do not match any of the expected values stored in data structure 90, it is known that the receiver 10 has been modified since its manufacture by changing one or more of the critical components or that some sort of an error has occurred. Therefore, the program provider 10 does not continue with the registration process, but instead sends an error message in step 117. In step 118, this error message is displayed by the receiver 60. If the receiver 60 is operationally connected to a television receiver 22 at this time, a textual message is displayed; otherwise an indication may be provided, for example, by lighting a red light. After transmitting the error message, the program provider 10 ends the telephone call in step 116.

A version of the subscription process of FIG. 5 is additionally used to change the programming to be decrypted, with transaction data exchanged in step 104 being used, for example, to modify the programming channels that can be received or to pay for particular pay-per-view programming. In step 108, the program provider 10 compares the hash values transmitted by the receiver 60 in step 106 with the values previously transmitted by this same receiver, which have been stored in the second data field 82 of the data record 78 corresponding to the receiver 60. If these values are the same, it is known that the critical components within the receiver 60 have not been changed since the last transmission from the receiver 60, so the service provider continues this process, with a new secret key being generated in step against When this occurs, a new secret key is generated in step 108, reflecting the change in the programming to be decrypted.

Preferably, the certificate is transmitted from the receiver 60 and evaluated by the program provider 10 with each transmission originated by the receiver. The certificate includes the public key of the receiver 60. If this is not done, the publlic key may be transmitted only when the receiver is initially registered, with the public key stored in the data structure 82 being subsequently used to encrypt the secret key.

The process of FIG. 5 may be performed to assure continued validation of the configuration of the receiver 60 on a periodic basis, such as on the hour, when programming changes, or as a part of the initialization process of FIG. 1, following step 98, in which hash codes are written to the PCR registers 70 in the TPM 68. Alternately, the service provider 10 may request the performance of this process through a command issued to the receiver 60 within a CA packet transmitted by the satellity 16.

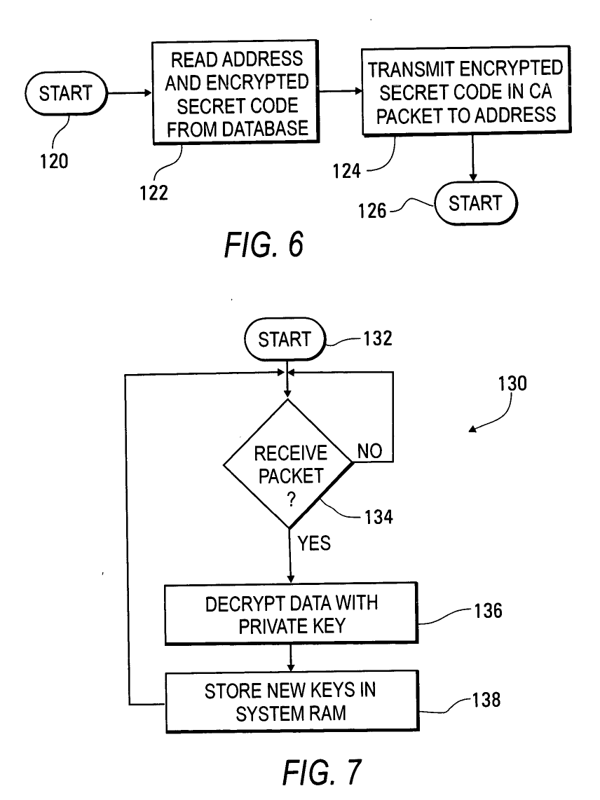

FIG. 6 is a flow chart of steps occurring within the computer system 74 during a process of verifying components within the receiver 60. As previously described in reference to FIG. 1, a conventional program provider 10 has an ability to transmit conditional access (CA) packets addressed to each individual DBS receiver. In accordance with the present invention, this ability is used to initiate a process for verifying that certain components within the receiver have not been changed. This verification process may be performed on a periodic basis, at particular times, such as the times when new programming is about to be transmitted, or as the computer system 74 and the channel for transmission of CA packets by means of the satellite 16 becomes available.

For each individual receiver 60, the verification process is started within the computer system 74 in step 120. Then, in step 122, the address of the receiver 70 and the encrypted secret key associated with the receiver 60 are read from the first field 80 and the third field 84, respectively, of the data record 78 within the database 76 corresponding to the receiver 70. Then, in step 124, the encrypted secret code is transmitted in a CA packet by means of the satellite 16, addressed to the particular receiver 60. Then, this portion of the verification process ends in step 126.

FIG. 7 is a flow chart of a subroutine executing within the microprocessor 64 of the receiver 60 for installing the updated secret key to be used to decrypt information. This key installation subroutine 130, which executes within the microprocessor 64 in response to instructions stored in ROM 63, may be run on a periodic basis or continuously when the receiver 60 is turned on to receive signals transmitted from the satellite 16, in a multitasking environment.

After starting in step 132, the verification subroutine 130 proceeds to step 134 to wait to receive a CA data packet transmitted from the satellite 16 and addressed particularly to the receiver 60. When such a data packet is received, the subroutine proceeds to step 136 to decrypt the data packet with the private key of the receiver 60, which is read from the key register 72 of the TPM 68. This decryption, which should be successful because the secret key has been encrypted using the public key of the receiver 60, results in the generation of the secret key to include a first portion for decrypting programming and a second portion including the hash codes stored in the PCRs 70 of the TPM 68.

While the transmission of signals over a single satellite 16 has been shown and described, this description is considered to represent the normal condition of communications over a number of orbiting satellites used sequentially.

While the invention has been described in its preferred versions or embodiments with some degree of particularity, it is understood that this description has only been given by way of example, and that numerous changes may be made without departing from the spirit and scope of the invention.

1. A receiver for receiving program content and for displaying said program content under predetermined conditions, wherein
said receiver comprises:
a component identified by a computer readable serial number,
data storage storing access data determining programming to be decrypted by said receiver, a public cryptographic key, a private cryptographic key for decrypting information encrypted with said public cryptographic key, and a code representing said component identifier, and
a signal processor decrypting said encrypted program content in accordance with said access data stored within said data storage; and
a first microprocessor,
said receiver periodically performs a first method comprising:
reading said computer readable serial number;
generating a hash value representing said computer readable serial number, and
storing said hash value in said data storage,
said receiver additionally performs a second method comprising:
reading said hash value from said data storage,
transmitting data indicating programming to be decrypted together with said hash value to a program provider, and
said receiver additionally performs a third method comprising:
receiving a secret code from said program provider;
decrypting said secret code with said private cryptographic key stored in said data storage; and
storing a decrypted form of said secret code as said access data in said data storage.

2. The receiver of claim 1, wherein
said receiver additionally comprises a second microprocessor,
said data storage includes a read-only key register storing said private cryptographic key from which data is read only by said second microprocessor and a program control register, storing said hash value, to which data is written only by said second microprocessor, from which data is read by said first microprocessor,
said second microprocessor reads said computer readable serial number on said periodic basis, generates said hash value, and stores said hash value in said program control register, and
said first microprocessor reads said hash value from said program control register and transmits said data indicating programming to be decrypted together with said hash value to said program provider.

3. The receiver of claim 1, wherein
said data storage additionally stores a digital certificate, and
said digital certificate is transmitted with said data indicating programming to be decrypted.

4. The receiver of claim 1, wherein
said receiver comprises a plurality of components identified by computer readable serial numbers,
said first method includes generating a hash value representing each of said computer readable serial numbers and storing each of said hash values in data storage, and
said second method includes transmitting data indicating programming to be deciphered together with each said hash value to said program provider.

5. The receiver of claim 1, wherein said receiver performs said first method whenever said receiver is turned on.

6. The receiver of claim 1, wherein said second method additionally includes transmitting transaction data for purchasing additional program content.

7. The receiver of claim 1, wherein a portion of information transmitted to said program provider during performance of said second method is encrypted with a private key of said receiver.

8. The receiver of claim 1, wherein a portion of information transmitted to said program provider during performance of said second method is encrypted with a public key of said program provider.

9. A computer system for controlling access to encrypted programming transmitted to a plurality of receivers from a program provider, wherein said computer system comprises:
input means for receiving data signals from each receiver in said plurality of receivers;
output means for transmitting a secret code indicating a portion of said encrypted programming to be displayed by each receiver in said plurality of receivers;
data storage;
a processor; and
a database storing a data record for each receiver in said plurality of receivers, wherein each said data record includes a first data field identifying an address for sending data to said receiver, a second data field for storing a hash value for said receiver, and a third data field for storing a public cryptographic key of said receiver.

10. The computer system of claim 9, wherein said processor is programmed to perform a first method including:
receiving a message from a receiver in said plurality of receivers including data identifying said receiver, data indicating programming to be decrypted by said receiver, and a hash value;
identifying a data record within said database from said data identifying said receiver,
determining said hash value received in said message matches said hash value stored in said data record,
generating a secret code identifying programming to be decrypted by said receiver,
encrypting said secret code with a public cryptographic key of said receiver stored in said data record to form an encrypted version of said secret code; and
transmitting said encrypted version of said secret code to said receiver.

11. The computer system of claim 10, wherein
said data record additionally includes a fourth data field storing said secret code, and
said first method additionally comprises storing said secret code in said data record.

12. The computer system of claim 10, wherein said processor is additionally programmed to perform a second method including:
receiving a message from an additional receiver including data requesting registration with said computer system, data identifying said additional receiver, a public cryptographic key of said receiver, and a hash value;
establishing an additional data record within said database associated with said additional receiver;
storing said data identifying said additional receiver, said public cryptographic key of said receiver, and said hash value to said additional data record
generating a secret code identifying programming to be decrypted by said additional receiver;
encrypting said secret code identifying programming to be decrypted by said additional receiver with said public cryptographic key of said additional receiver to form an encrypted version of said secret code identifying programming to be decrypted by said additional receiver; and
transmitting said encrypted version of said secret code identifying programming to be decrypted by said additional receiver to said additional receiver.

13. The computer system of claim 12, wherein
said data record additionally includes a fourth data field storing said secret code, and
said second method additionally includes storing said secret code identifying programming to be decrypted by said additional receiver in said additional data record.

14. The computer system of claim 12, wherein
said computer system additionally includes data storage storing a data structure including a plurality of hash values of receivers received from one or more manufacturers of said receivers, and
said second method additionally includes determining that said hash value matches a hash value within said plurality of hash values before transmitting said encrypted version of said secret code identifying programming to be decrypted by said additional receiver to said additional receiver.

15. The computer system of claim 14, wherein said second method additionally includes determining validity of a digital certificate in which said public cryptographic key is transmitted.

16. The computer system of claim 12, wherein
said second data field stores a first plurality of hash values for said receiver,
said first method includes receiving a second plurality of hash values within said message from said receiver and determining whether said each of said second plurality of hash values matches a hash value within said first plurality of hash values, and
said second method includes receiving a third plurality of hash values within said message from said additional receiver and storing said third plurality of hash values in said additional data record.

17. The computer system of claim 12, wherein said first and second methods each additionally includes performing a transaction for purchasing program content.

18. A method for broadcasting program content from a program provider and displaying a portion of said program content at a receiver, wherein said method comprises:
a) generating a hash value within said receiver, wherein said hash value represents a computer readable serial number of a component within said receiver;
b) storing said hash value in data storage within said receiver;
c) reading said hash value from data storage,
d) transmitting data indicating programming to be decrypted together with data identifying said receiver and said hash value to a program provider,
e) finding a data record within a database accessed by said program provider including said data identifying said receiver;
f) matching said hash value transmitted from said receiver with a hash value stored within said data record;
g) generating a secret code identifying said programming to be decrypted;
h) encrypting said secret code with a public cryptographic key of said receiver stored within said data record to form an encrypted version of said secret code;
i) transmitting said secret code from said program provider to said receiver;
k) decrypting said encrypted secret code within said receiver with a private cryptographic key stored within said receiver; and
l) decrypting said portion of said program content with said secret code within said receiver.

19. The method of claim 18, wherein step d) is preceded by:
m) transmitting data indicating said receiver is to be registered with said program provider, said public cryptographic key of said receiver, and said hash value from said receiver to said program provider;
n) establishing an additional data record within said database accessed by said program provider; and
o) storing said data indicating said receiver is to be registered with said program provider, said public cryptographic key of said receiver, and said hash value from said receiver in said additional data record.

20. The method of claim 19, wherein step o) is preceded by:
p) receiving a plurality of hash values from one or more manufacturers of said receivers;
q) storing said plurality of hash values in a data structure accessed by said program provider; and
r) determining that said hash value transmitted by said receiver matches a hash value stored in said data structure.

21. The method of claim 20, wherein steps a) and b) are performed during initialization each time power is turned on at said receiver.

22. A computer readable medium storing program code causing a microprocessor controlling a receiver to perform a method including:
reading a hash value from data storage within said receiver,
transmitting data indicating programming to be decrypted together with said hash value to a program provider;
receiving a secret code from said program provider;
decrypting said secret code with a private cryptographic key stored in said data storage; and
storing a decrypted form of said secret code for use to decrypt program content in said data storage.

23. A computer data signal embodied in a carrier wave comprising program code causing a microprocessor controlling a receiver to perform a method including:
reading a hash value from data storage within said receiver,
transmitting data indicating programming to be decrypted together with said hash value to a program provider;
receiving a secret code from said program provider;
decrypting said secret code with a private cryptographic key stored in said data storage; and
storing a decrypted form of said secret code for use to decrypt program content in said data storage.

24. A computer readable medium storing program code causing a computer system to perform a method comprising:
receiving a message from a receiver in a plurality of receivers including data identifying said receiver, data indicating programming to be decrypted by said receiver, and a hash value;
identifying a data record within a database from said data identifying said receiver,
determining said hash value received in said message matches a hash value stored in said data record,
generating a secret code identifying programming to be decrypted by said receiver,
encrypting said secret code with a public cryptographic key of said receiver stored in said data record to form an encrypted version of said secret code; and
transmitting said encrypted version of said secret code to said receiver.

25. A computer data signal embodied in a carrier wave comprising program code causing a computer to perform a method comprising:
receiving a message from a receiver in a plurality of receivers including data identifying said receiver, data indicating programming to be decrypted by said receiver, and a hash value;
identifying a data record within a database from said data identifying said receiver,
determining said hash value received in said message matches a hash value stored in said data record,
generating a secret code identifying programming to be decrypted by said receiver,
encrypting said secret code with a public cryptographic key of said receiver stored in said data record to form an encrypted version of said secret code; and
transmitting said encrypted version of said secret code to said receiver.

26. A computer readable medium storing program code causing a computer system to perform a method comprising:
receiving a message from a receiver including data requesting registration with said computer system, data identifying said receiver, a public cryptographic key of said receiver, and a hash value;
establishing an additional data record within a database associated with said receiver;
storing said data identifying said receiver, said public cryptographic key of said receiver, and said hash value to said additional data record
generating a secret code identifying programming to be decrypted by said receiver;
encrypting said secret code identifying programming to be decrypted by said receiver with said public cryptographic key of said receiver to form an encrypted version of said secret code identifying programming to be decrypted by said receiver; and
transmitting said encrypted version of said secret code identifying programming to be decrypted by said receiver to said receiver.

27. The computer readable medium of claim 26, wherein said method additionally includes determining that said hash value received from said receiver matches a hash value within a plurality of hash values received from one or more manufacturers of said receivers before transmitting said encrypted version of said secret code identifying programming to be decrypted by said receiver to said receiver.

28 A computer data signal embodied in a carrier wave comprising program code causing a computer to perform a method comprising:
receiving a message from a receiver including data requesting registration with said computer system, data identifying said receiver, a public cryptographic key of said receiver, and a hash value;
establishing an additional data record within a database associated with said receiver;
storing said data identifying said receiver, said public cryptographic key of said receiver, and said hash value to said additional data record
generating a secret code identifying programming to be decrypted by said receiver;
encrypting said secret code identifying programming to be decrypted by said receiver with said public cryptographic key of said receiver to form an encrypted version of said secret code identifying programming to be decrypted by said receiver; and
transmitting said encrypted version of said secret code identifying programming to be decrypted by said receiver to said receiver.

29. The computer data signal of claim 28, wherein said method additionally includes determining that said hash value received from said receiver matches a hash value within a plurality of hash values received from one or more manufacturers of said receivers before transmitting said encrypted version of said secret code identifying programming to be decrypted by said receiver to said receiver.
